(19) United States
(12) Patent Application Publication
(10) Pub. No.: US 2026/0161392 A1
(43) Pub. Date: Jun. 11, 2026

(54) Apparatus And Method For Memory Alias Disambiguation Training

(71) Applicant: Intel Corporation, Santa Clara, CA (US)

(72) Inventors: Sudeepto MAJUMDAR, Hillsboro, OR (US); Mark DECHENE, Hillsboro, OR (US); Michael MEEUWSEN, Hillsboro, OR (US); Meenakshi MARATHE, Hillsboro, OR (US); Brendan WEST, Hillsboro, OR (US)

(21) Appl. No.: 18/972,351

(22) Filed: Dec. 6, 2024

(51) Int. Cl. G06F 9/22; G06F 9/24

(52) U.S. Cl. CPC G06F 9/223; G06F 9/24

(57) ABSTRACT

Embodiments of a processor for MAD training comprise: decode circuitry to decode instructions into uops, including a plurality of load and store uops; memory execution circuitry executes the plurality of load uops to load data from a memory subsystem and to execute the plurality of store uops to store data to the memory subsystem; and memory alias disambiguation (MAD) prediction circuitry to make a prediction as to whether a first load uop of the plurality of load uops can be executed prior to execution of a first one or more store uops of the plurality of store uops without causing a conflict, the MAD circuitry to make the prediction based on first prediction circuitry when a first confidence value indicated by the first prediction circuitry is above a threshold and to make the prediction based on second prediction circuitry when the first confidence value is at or below the threshold.

### BACKGROUND

### Field of the Invention

This invention relates generally to the field of computer processors. More particularly, the invention relates to an apparatus and method for memory alias disambiguation training.

### Description of the Related Art

In modern processors with wide memory pipelines, it is crucial that loads are able to make forward progress accurately to avoid bottlenecks in other parts of the pipeline. Prefetching with speculative load execution can be performed in an attempt to reduce load latency. However, one of the primary limitations with executing a speculative load is the inability to discern and skip past unresolved store addresses that are older than the speculative load.

### BRIEF DESCRIPTION OF THE DRAWINGS

A better understanding of the present invention can be obtained from the following detailed description in conjunction with the following drawings, in which:

FIG. 1 illustrates an example computer system architecture.

FIG. 2 illustrates a processor comprising a plurality of cores.

FIG. 3A illustrates a plurality of stages of a processing pipeline.

FIG. 3B illustrates details of one embodiment of a core.

FIG. 4 illustrates execution circuitry in accordance with one embodiment.

FIG. 5 illustrates one embodiment of a register architecture.

FIG. 6 illustrates one example of an instruction format.

FIG. 7 illustrates addressing techniques in accordance with one embodiment.

FIG. 8 illustrates one embodiment of an instruction prefix.

FIGS. 9A-D illustrate embodiments of how the R, X, and B fields of the prefix are used.

FIGS. 10A-B illustrate examples of a second instruction prefix.

FIG. 11 illustrates payload bytes of one embodiment of an instruction prefix.

FIG. 12 illustrates instruction conversion and binary translation implementations.

FIG. 13 illustrates a processor or core architecture in accordance with some embodiments of the invention.

FIG. 14 illustrates an example core pipeline including a memory alias disambiguation (MAD) predictor.

FIG. 15 illustrates an example of a MAD predictor in accordance with an embodiment of the invention.

FIG. 16 illustrates example store set ID (SSID) values based on lookups in a memory alias disambiguation load table and a memory alias disambiguation store table.

FIG. 17 illustrates examples of store set resolutions for generating a resultant store set ID in accordance with embodiments of the invention.

FIG. 18 illustrates an architecture for communicating training packets to update a memory alias disambiguation load table and a memory alias disambiguation store table in accordance with embodiments of the invention.

FIG. 19 illustrates a method in accordance with embodiments of the invention.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

### Exemplary Computer Architectures

Detailed below are describes of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

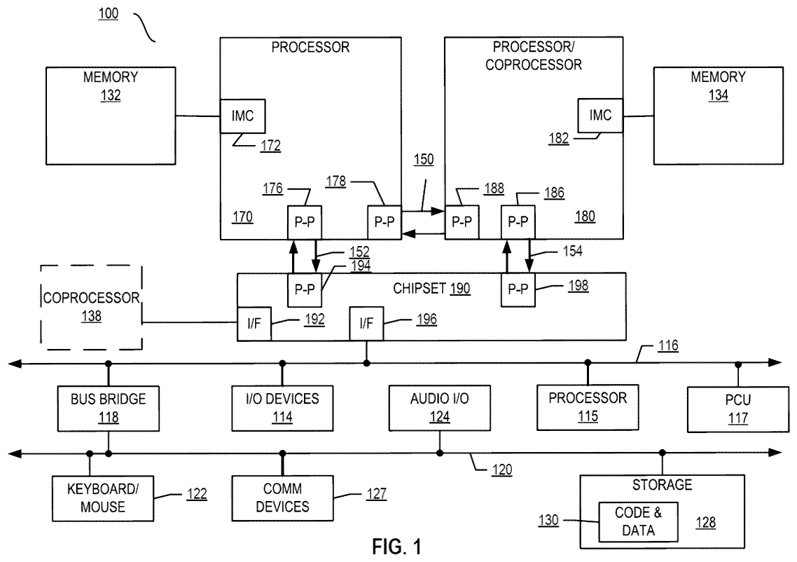

FIG. 1 illustrates embodiments of an exemplary system. Multiprocessor system 100 is a point-to-point interconnect system and includes a plurality of processors including a first processor 170 and a second processor 180 coupled via a point-to-point interconnect 150. In some embodiments, the first processor 170 and the second processor 180 are homogeneous. In some embodiments, first processor 170 and the second processor 180 are heterogenous.

Processors 170 and 180 are shown including integrated memory controller (IMC) units circuitry 172 and 182, respectively. Processor 170 also includes as part of its interconnect controller units point-to-point (P-P) interfaces 176 and 178; similarly, second processor 180 includes P-P interfaces 186 and 188. Processors 170, 180 may exchange information via the point-to-point (P-P) interconnect 150 using P-P interface circuits 178, 188. IMCs 172 and 182 couple the processors 170, 180 to respective memories, namely a memory 132 and a memory 134, which may be portions of main memory locally attached to the respective processors.

Processors 170, 180 may each exchange information with a chipset 190 via individual P-P interconnects 152, 154 using point to point interface circuits 176, 194, 186, 198. Chipset 190 may optionally exchange information with a coprocessor 138 via a high-performance interface 192. In some embodiments, the coprocessor 138 is a special-purpose processor, such as, for example, a high-throughput MIC processor, a network or communication processor, compression engine, graphics processor, GPGPU, embedded processor, or the like.

A shared cache (not shown) may be included in either processor 170, 180 or outside of both processors, yet connected with the processors via P-P interconnect, such that either or both processors' local cache information may be stored in the shared cache if a processor is placed into a low power mode.

Chipset 190 may be coupled to a first interconnect 116 via an interface 196. In some embodiments, first interconnect 116 may be a Peripheral Component Interconnect (PCI) interconnect, or an interconnect such as a PCI Express interconnect or another I/O interconnect. In some embodiments, one of the interconnects couples to a power control unit (PCU) 117, which may include circuitry, software, and/or firmware to perform power management operations with regard to the processors 170, 180 and/or co-processor 138. PCU 117 provides control information to a voltage regulator to cause the voltage regulator to generate the appropriate regulated voltage. PCU 117 also provides control information to control the operating voltage generated. In various embodiments, PCU 117 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 117 is illustrated as being present as logic separate from the processor 170 and/or processor 180. In other cases, PCU 117 may execute on a given one or more of cores (not shown) of processor 170 or 180. In some cases, PCU 117 may be implemented as a microcontroller (dedicated or general-purpose) or other control logic configured to execute its own dedicated power management code, sometimes referred to as P-code. In yet other embodiments, power management operations to be performed by PCU 117 may be implemented externally to a processor, such as by way of a separate power management integrated circuit (PMIC) or another component external to the processor. In yet other embodiments, power management operations to be performed by PCU 117 may be implemented within BIOS or other system software.

Various I/O devices 114 may be coupled to first interconnect 116, along with an interconnect (bus) bridge 118 which couples first interconnect 116 to a second interconnect 120. In some embodiments, one or more additional processor(s) 115, such as coprocessors, high-throughput MIC processors, GPGPU's, accelerators (such as, e.g., graphics accelerators or digital signal processing (DSP) units), field programmable gate arrays (FPGAs), or any other processor, are coupled to first interconnect 116. In some embodiments, second interconnect 120 may be a low pin count (LPC) interconnect. Various devices may be coupled to second interconnect 120 including, for example, a keyboard and/or mouse 122, communication devices 127 and a storage unit circuitry 128. Storage unit circuitry 128 may be a disk drive or other mass storage device which may include instructions/code and data 130, in some embodiments. Further, an audio I/O 124 may be coupled to second interconnect 120. Note that other architectures than the point-to-point architecture described above are possible. For example, instead of the point-to-point architecture, a system such as multiprocessor system 100 may implement a multi-drop interconnect or other such architecture.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die as the described CPU (sometimes referred to as the application core(s) or application processor(s)), the above described coprocessor, and additional functionality. Exemplary core architectures are described next, followed by descriptions of exemplary processors and computer architectures.

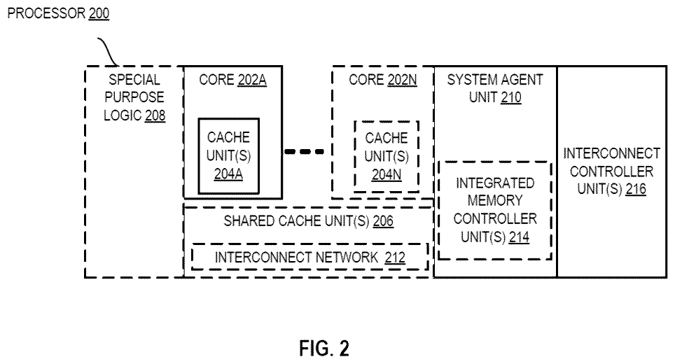

FIG. 2 illustrates a block diagram of embodiments of a processor 200 that may have more than one core, may have an integrated memory controller, and may have integrated graphics. The solid lined boxes illustrate a processor 200 with a single core 202A, a system agent 210, a set of one or more interconnect controller units circuitry 216, while the optional addition of the dashed lined boxes illustrates an alternative processor 200 with multiple cores 202(A)-(N), a set of one or more integrated memory controller unit(s) circuitry 214 in the system agent unit circuitry 210, and special purpose logic 208, as well as a set of one or more interconnect controller units circuitry 216. Note that the processor 200 may be one of the processors 170 or 180, or co-processor 138 or 115 of FIG. 1.

Thus, different implementations of the processor 200 may include: 1) a CPU with the special purpose logic 208 being integrated graphics and/or scientific (throughput) logic (which may include one or more cores, not shown), and the cores 202(A)-(N) being one or more general purpose cores (e.g., general purpose in-order cores, general purpose out-of-order cores, or a combination of the two); 2) a coprocessor with the cores 202(A)-(N) being a large number of special purpose cores intended primarily for graphics and/or scientific (throughput); and 3) a coprocessor with the cores 202(A)-(N) being a large number of general purpose in-order cores. Thus, the processor 200 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 200 may be a part of and/or may be implemented on one or more substrates using any of a number of process technologies, such as, for example, BiCMOS, CMOS, or NMOS.

A memory hierarchy includes one or more levels of cache unit(s) circuitry 204(A)-(N) within the cores 202(A)-(N), a set of one or more shared cache units circuitry 206, and external memory (not shown) coupled to the set of integrated memory controller units circuitry 214. The set of one or more shared cache units circuitry 206 may include one or more mid-level caches, such as level 2 (L2), level 3 (L3), level 4 (L4), or other levels of cache, such as a last level cache (LLC), and/or combinations thereof. While in some embodiments ring-based interconnect network circuitry 212 interconnects the special purpose logic 208 (e.g., integrated graphics logic), the set of shared cache units circuitry 206, and the system agent unit circuitry 210, alternative embodiments use any number of well-known techniques for interconnecting such units. In some embodiments, coherency is maintained between one or more of the shared cache units circuitry 206 and cores 202(A)-(N).

In some embodiments, one or more of the cores 202(A)-(N) are capable of multi-threading. The system agent unit circuitry 210 includes those components coordinating and operating cores 202(A)-(N). The system agent unit circuitry 210 may include, for example, power control unit (PCU) circuitry and/or display unit circuitry (not shown). The PCU may be or may include logic and components needed for regulating the power state of the cores 202(A)-(N) and/or the special purpose logic 208 (e.g., integrated graphics logic). The display unit circuitry is for driving one or more externally connected displays.

The cores 202(A)-(N) may be homogenous or heterogeneous in terms of architecture instruction set; that is, two or more of the cores 202(A)-(N) may be capable of executing the same instruction set, while other cores may be capable of executing only a subset of that instruction set or a different instruction set.

### Exemplary Core Architectures

### In-Order and Out-of-Order Core Block Diagram

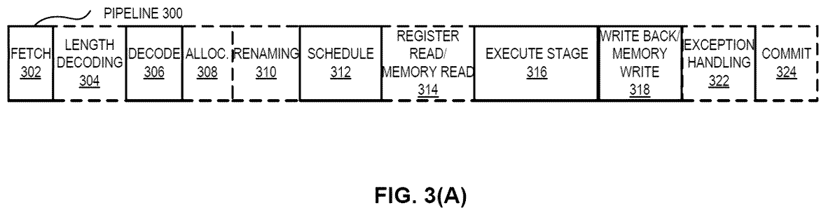

FIG. 3(A) is a block diagram illustrating both an exemplary in-order pipeline and an exemplary register renaming, out-of-order issue/execution pipeline according to embodiments of the invention. FIG. 3(B) is a block diagram illustrating both an exemplary embodiment of an in-order architecture core and an exemplary register renaming, out-of-order issue/execution architecture core to be included in a processor according to embodiments of the invention. The solid lined boxes in FIGS. 3(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 3(A), a processor pipeline 300 includes a fetch stage 302, an optional length decode stage 304, a decode stage 306, an optional allocation stage 308, an optional renaming stage 310, a scheduling (also known as a dispatch or issue) stage 312, an optional register read/memory read stage 314, an execute stage 316, a write back/memory write stage 318, an optional exception handling stage 322, and an optional commit stage 324. One or more operations can be performed in each of these processor pipeline stages. For example, during the fetch stage 302, one or more instructions are fetched from instruction memory, during the decode stage 306, the one or more fetched instructions may be decoded, addresses (e.g., load store unit (LSU) addresses) using forwarded register ports may be generated, and branch forwarding (e.g., immediate offset or an link register (LR)) may be performed. In one embodiment, the decode stage 306 and the register read/memory read stage 314 may be combined into one pipeline stage. In one embodiment, during the execute stage 316, the decoded instructions may be executed, LSU address/data pipelining to an Advanced Microcontroller Bus (AHB) interface may be performed, multiply and add operations may be performed, arithmetic operations with branch results may be performed, etc.

By way of example, the exemplary register renaming, out-of-order issue/execution core architecture may implement the pipeline 300 as follows: 1) the instruction fetch 338 performs the fetch and length decoding stages 302 and 304; 2) the decode unit circuitry 340 performs the decode stage 306; 3) the rename/allocator unit circuitry 352 performs the allocation stage 308 and renaming stage 310; 4) the scheduler unit(s) circuitry 356 performs the schedule stage 312; 5) the physical register file(s) unit(s) circuitry 358 and the memory unit circuitry 370 perform the register read/memory read stage 314; the execution cluster 360 perform the execute stage 316; 6) the memory unit circuitry 370 and the physical register file(s) unit(s) circuitry 358 perform the write back/memory write stage 318; 7) various units (unit circuitry) may be involved in the exception handling stage 322; and 8) the retirement unit circuitry 354 and the physical register file(s) unit(s) circuitry 358 perform the commit stage 324.

FIG. 3(B) shows processor core 390 including front-end unit circuitry 330 coupled to an execution engine unit circuitry 350, and both are coupled to a memory unit circuitry 370. The core 390 may be a reduced instruction set computing (RISC) core, a complex instruction set computing (CISC) core, a very long instruction word (VLIW) core, or a hybrid or alternative core type. As yet another option, the core 390 may be a special-purpose core, such as, for example, a network or communication core, compression engine, coprocessor core, general purpose computing graphics processing unit (GPGPU) core, graphics core, or the like.

The front end unit circuitry 330 may include branch prediction unit circuitry 332 coupled to an instruction cache unit circuitry 334, which is coupled to an instruction translation lookaside buffer (TLB) 336, which is coupled to instruction fetch unit circuitry 338, which is coupled to decode unit circuitry 340. In one embodiment, the instruction cache unit circuitry 334 is included in the memory unit circuitry 370 rather than the front-end unit circuitry 330. The decode unit circuitry 340 (or decoder) may decode instructions, and generate as an output one or more micro-operations, micro-code entry points, microinstructions, other instructions, or other control signals, which are decoded from, or which otherwise reflect, or are derived from, the original instructions. The decode unit circuitry 340 may further include an address generation unit circuitry (AGU, not shown). In one embodiment, the AGU generates an LSU address using forwarded register ports, and may further perform branch forwarding (e.g., immediate offset branch forwarding, LR register branch forwarding, etc.). The decode unit circuitry 340 may be implemented using various different mechanisms. Examples of suitable mechanisms include, but are not limited to, look-up tables, hardware implementations, programmable logic arrays (PLAs), microcode read only memories (ROMs), etc. In one embodiment, the core 390 includes a microcode ROM (not shown) or other medium that stores microcode for certain macroinstructions (e.g., in decode unit circuitry 340 or otherwise within the front end unit circuitry 330). In one embodiment, the decode unit circuitry 340 includes a micro-operation (micro-op) or operation cache (not shown) to hold/cache decoded operations, micro-tags, or micro-operations generated during the decode or other stages of the processor pipeline 300. The decode unit circuitry 340 may be coupled to rename/allocator unit circuitry 352 in the execution engine unit circuitry 350.

The execution engine circuitry 350 includes the rename/allocator unit circuitry 352 coupled to a retirement unit circuitry 354 and a set of one or more scheduler(s) circuitry 356. The scheduler(s) circuitry 356 represents any number of different schedulers, including reservations stations, central instruction window, etc. In some embodiments, the scheduler(s) circuitry 356 can include arithmetic logic unit (ALU) scheduler/scheduling circuitry, ALU queues, arithmetic generation unit (AGU) scheduler/scheduling circuitry, AGU queues, etc. The scheduler(s) circuitry 356 is coupled to the physical register file(s) circuitry 358. Each of the physical register file(s) circuitry 358 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one embodiment, the physical register file(s) unit circuitry 358 includes vector registers unit circuitry, writemask registers unit circuitry, and scalar register unit circuitry. These register units may provide architectural vector registers, vector mask registers, general-purpose registers, etc. The physical register file(s) unit(s) circuitry 358 is overlapped by the retirement unit circuitry 354 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 354 and the physical register file(s) circuitry 358 are coupled to the execution cluster(s) 360. The execution cluster(s) 360 includes a set of one or more execution units circuitry 362 and a set of one or more memory access circuitry 364. The execution units circuitry 362 may perform various arithmetic, logic, floating-point or other types of operations (e.g., shifts, addition, subtraction, multiplication) and on various types of data (e.g., scalar floating-point, packed integer, packed floating-point, vector integer, vector floating-point). While some embodiments may include a number of execution units or execution unit circuitry dedicated to specific functions or sets of functions, other embodiments may include only one execution unit circuitry or multiple execution units/execution unit circuitry that all perform all functions. The scheduler(s) circuitry 356, physical register file(s) unit(s) circuitry 358, and execution cluster(s) 360 are shown as being possibly plural because certain embodiments create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) unit circuitry, and/or execution cluster—and in the case of a separate memory access pipeline, certain embodiments are implemented in which only the execution cluster of this pipeline has the memory access unit(s) circuitry 364). It should also be understood that where separate pipelines are used, one or more of these pipelines may be out-of-order issue/execution and the rest in-order.

In some embodiments, the execution engine unit circuitry 350 may perform load store unit (LSU) address/data pipelining to an Advanced Microcontroller Bus (AHB) interface (not shown), and address phase and writeback, data phase load, store, and branches.

The set of memory access circuitry 364 is coupled to the memory unit circuitry 370, which includes data TLB unit circuitry 372 coupled to a data cache circuitry 374 coupled to a level 2 (L2) cache circuitry 376. In one exemplary embodiment, the memory access units circuitry 364 may include a load unit circuitry, a store address unit circuit, and a store data unit circuitry, each of which is coupled to the data TLB circuitry 372 in the memory unit circuitry 370. The instruction cache circuitry 334 is further coupled to a level 2 (L2) cache unit circuitry 376 in the memory unit circuitry 370. In one embodiment, the instruction cache 334 and the data cache 374 are combined into a single instruction and data cache (not shown) in L2 cache unit circuitry 376, a level 3 (L3) cache unit circuitry (not shown), and/or main memory. The L2 cache unit circuitry 376 is coupled to one or more other levels of cache and eventually to a main memory.

The core 390 may support one or more instructions sets (e.g., the x86 instruction set (with some extensions that have been added with newer versions); the MIPS instruction set; the ARM instruction set (with optional additional extensions such as NEON)), including the instruction(s) described herein. In one embodiment, the core 390 includes logic to support a packed data instruction set extension (e.g., AVX1, AVX2), thereby allowing the operations used by many multimedia applications to be performed using packed data.

### Exemplary Execution Unit(s) Circuitry

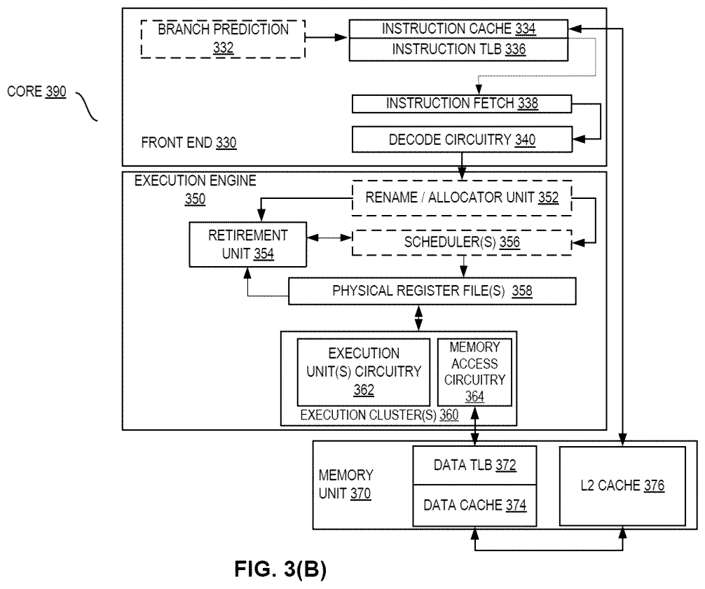

FIG. 4 illustrates embodiments of execution unit(s) circuitry, such as execution unit(s) circuitry 362 of FIG. 3(B). As illustrated, execution unit(s) circuitry 362 may include one or more ALU circuits 401, vector/SIMD unit circuits 403, load/store unit circuits 405, and/or branch/jump unit circuits 407. ALU circuits 401 perform integer arithmetic and/or Boolean operations. Vector/SIMD unit circuits 403 perform vector/SIMD operations on packed data (such as SIMD/vector registers). Load/store unit circuits 405 execute load and store instructions to load data from memory into registers or store from registers to memory. Load/store unit circuits 405 may also generate addresses. Branch/jump unit circuits 407 cause a branch or jump to a memory address depending on the instruction. Floating-point unit (FPU) circuits 409 perform floating-point arithmetic. The width of the execution unit(s) circuitry 362 varies depending upon the embodiment and can range from 16-bit to 1,024-bit. In some embodiments, two or more smaller execution units are logically combined to form a larger execution unit (e.g., two 128-bit execution units are logically combined to form a 256-bit execution unit).

### Exemplary Register Architecture

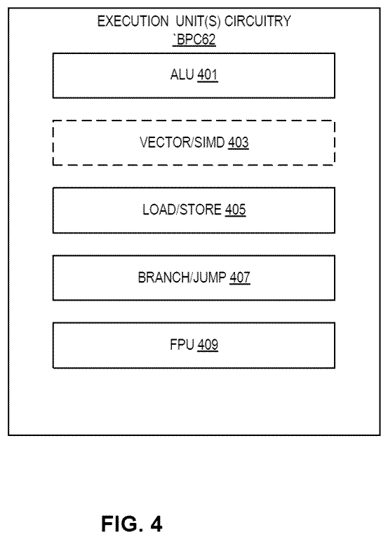

FIG. 5 is a block diagram of a register architecture 500 according to some embodiments. As illustrated, there are vector/SIMD registers 510 that vary from 128-bit to 1,024 bits width. In some embodiments, the vector/SIMD registers 510 are physically 512-bits and, depending upon the mapping, only some of the lower bits are used. For example, in some embodiments, the vector/SIMD registers 510 are ZMM registers which are 512 bits: the lower 256 bits are used for YMM registers and the lower 128 bits are used for XMM registers. As such, there is an overlay of registers. In some embodiments, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the embodiment.

In some embodiments, the register architecture 500 includes writemask/predicate registers 515. For example, in some embodiments, there are 8 writemask/predicate registers (sometimes called k0 through k7) that are each 16-bit, 32-bit, 64-bit, or 128-bit in size. Writemask/predicate registers 515 may allow for merging (e.g., allowing any set of elements in the destination to be protected from updates during the execution of any operation) and/or zeroing (e.g., zeroing vector masks allow any set of elements in the destination to be zeroed during the execution of any operation). In some embodiments, each data element position in a given writemask/predicate register 515 corresponds to a data element position of the destination. In other embodiments, the writemask/predicate registers 515 are scalable and consists of a set number of enable bits for a given vector element (e.g., 8 enable bits per 64-bit vector element).

The register architecture 500 includes a plurality of general-purpose registers 525. These registers may be 16-bit, 32-bit, 64-bit, etc. and can be used for scalar operations. In some embodiments, these registers are referenced by the names RAX, RBX, RCX, RDX, RBP, RSI, RDI, RSP, and R8 through R15.

In some embodiments, the register architecture 500 includes scalar floating-point register 545 which is used for scalar floating-point operations on 32/64/80-bit floating-point data using the x87 instruction set extension or as MMX registers to perform operations on 64-bit packed integer data, as well as to hold operands for some operations performed between the MMX and XMM registers.

One or more flag registers 540 (e.g., EFLAGS, RFLAGS, etc.) store status and control information for arithmetic, compare, and system operations. For example, the one or more flag registers 540 may store condition code information such as carry, parity, auxiliary carry, zero, sign, and overflow. In some embodiments, the one or more flag registers 540 are called program status and control registers.

Segment registers 520 contain segment points for use in accessing memory. In some embodiments, these registers are referenced by the names CS, DS, SS, ES, FS, and GS.

Machine specific registers (MSRs) 535 control and report on processor performance. Most MSRs 535 handle system-related functions and are not accessible to an application program. Machine check registers 560 consist of control, status, and error reporting MSRs that are used to detect and report on hardware errors.

One or more instruction pointer register(s) 530 store an instruction pointer value. Control register(s) 555 (e.g., CR0-CR4) determine the operating mode of a processor (e.g., processor 170, 180, 138, 115, and/or 200) and the characteristics of a currently executing task. Debug registers 550 control and allow for the monitoring of a processor or core's debugging operations.

Memory management registers 565 specify the locations of data structures used in protected mode memory management. These registers may include a GDTR, IDRT, task register, and a LDTR register.

Alternative embodiments of the invention may use wider or narrower registers. Additionally, alternative embodiments of the invention may use more, less, or different register files and registers.

### Instruction Sets

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands.

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

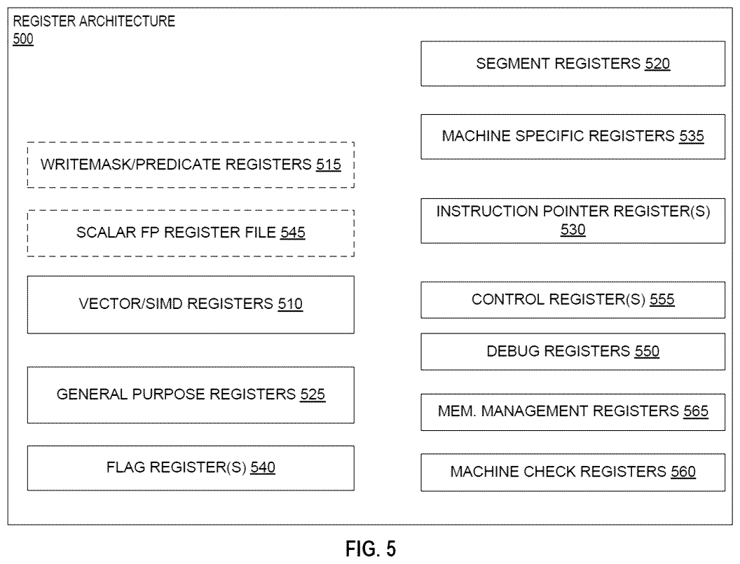

FIG. 6 illustrates embodiments of an instruction format. As illustrated, an instruction may include multiple components including, but not limited to, one or more fields for: one or more prefixes 601, an opcode 603, addressing information 605 (e.g., register identifiers, memory addressing information, etc.), a displacement value 607, and/or an immediate 609. Note that some instructions utilize some or all of the fields of the format whereas others may only use the field for the opcode 603. In some embodiments, the order illustrated is the order in which these fields are to be encoded, however, it should be appreciated that in other embodiments these fields may be encoded in a different order, combined, etc.

The prefix(es) field(s) 601, when used, modifies an instruction. In some embodiments, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 603 is used to at least partially define the operation to be performed upon a decoding of the instruction. In some embodiments, a primary opcode encoded in the opcode field 603 is 1, 2, or 3 bytes in length. In other embodiments, a primary opcode can be a different length. An additional 3-bit opcode field is sometimes encoded in another field.

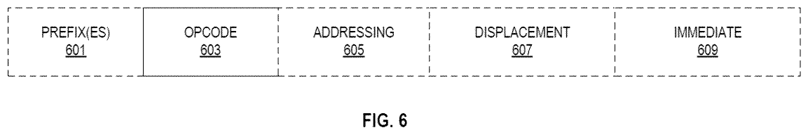

The addressing field 605 is used to address one or more operands of the instruction, such as a location in memory or one or more registers. FIG. 7 illustrates embodiments of the addressing field 605. In this illustration, an optional ModR/M byte 702 and an optional Scale, Index, Base (SIB) byte 704 are shown. The ModR/M byte 702 and the SIB byte 704 are used to encode up to two operands of an instruction, each of which is a direct register or effective memory address. Note that each of these fields are optional in that not all instructions include one or more of these fields. The MOD R/M byte 702 includes a MOD field 742, a register field 744, and R/M field 746.

The content of the MOD field 742 distinguishes between memory access and non-memory access modes. In some embodiments, when the MOD field 742 has a value of b11, a register-direct addressing mode is utilized, and otherwise register-indirect addressing is used.

The register field 744 may encode either the destination register operand or a source register operand, or may encode an opcode extension and not be used to encode any instruction operand. The content of register index field 744, directly or through address generation, specifies the locations of a source or destination operand (either in a register or in memory). In some embodiments, the register field 744 is supplemented with an additional bit from a prefix (e.g., prefix 601) to allow for greater addressing.

The R/M field 746 may be used to encode an instruction operand that references a memory address, or may be used to encode either the destination register operand or a source register operand. Note the R/M field 746 may be combined with the MOD field 742 to dictate an addressing mode in some embodiments.

The SIB byte 704 includes a scale field 752, an index field 754, and a base field 756 to be used in the generation of an address. The scale field 752 indicates scaling factor. The index field 754 specifies an index register to use. In some embodiments, the index field 754 is supplemented with an additional bit from a prefix (e.g., prefix 601) to allow for greater addressing. The base field 756 specifies a base register to use. In some embodiments, the base field 756 is supplemented with an additional bit from a prefix (e.g., prefix 601) to allow for greater addressing. In practice, the content of the scale field 752 allows for the scaling of the content of the index field 754 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some embodiments, a displacement field 607 provides this value. Additionally, in some embodiments, a displacement factor usage is encoded in the MOD field of the addressing field 605 that indicates a compressed displacement scheme for which a displacement value is calculated by multiplying disp8 in conjunction with a scaling factor N that is determined based on the vector length, the value of a b bit, and the input element size of the instruction. The displacement value is stored in the displacement field 607.

In some embodiments, an immediate field 609 specifies an immediate for the instruction. An immediate may be encoded as a 1-byte value, a 2-byte value, a 4-byte value, etc.

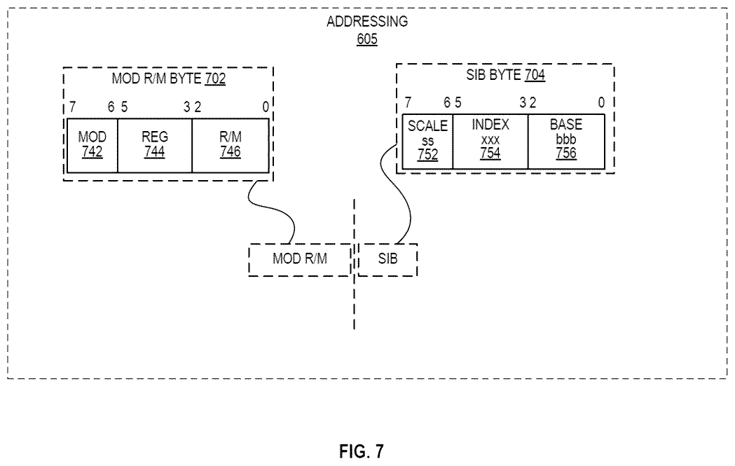

FIG. 8 illustrates embodiments of a first prefix 601(A). In some embodiments, the first prefix 601(A) is an embodiment of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 601(A) may specify up to three registers using 3-bit fields depending on the format: 1) using the reg field 744 and the R/M field 746 of the Mod R/M byte 702; 2) using the Mod R/M byte 702 with the SIB byte 704 including using the reg field 744 and the base field 756 and index field 754; or 3) using the register field of an opcode.

In the first prefix 601(A), bit positions 7:4 are set as 0100. Bit position 3 (W) can be used to determine the operand size, but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 744 and MOD R/M R/M field 746 alone can each only address 8 registers.

In the first prefix 601(A), bit position 2 (R) may an extension of the MOD R/M reg field 744 and may be used to modify the ModR/M reg field 744 when that field encodes a general purpose register, a 64-bit packed data register (e.g., a SSE register), or a control or debug register. R is ignored when Mod R/M byte 702 specifies other registers or defines an extended opcode.

Bit position 1 (X) X bit may modify the SIB byte index field 754.

Bit position B (B) B may modify the base in the Mod R/M R/M field 746 or the SIB byte base field 756; or it may modify the opcode register field used for accessing general purpose registers (e.g., general purpose registers 525).

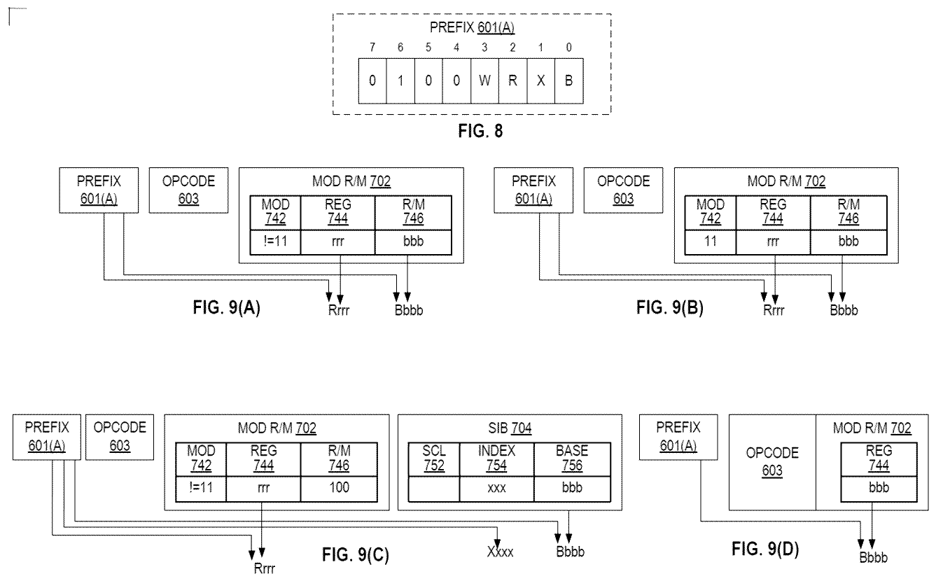

FIGS. 9(A)-(D) illustrate embodiments of how the R, X, and B fields of the first prefix 601(A) are used. FIG. 9(A) illustrates R and B from the first prefix 601(A) being used to extend the reg field 744 and R/M field 746 of the MOD R/M byte 702 when the SIB byte 7 04 is not used for memory addressing. FIG. 9(B) illustrates R and B from the first prefix 601(A) being used to extend the reg field 744 and R/M field 746 of the MOD R/M byte 702 when the SIB byte 7 04 is not used (register-register addressing). FIG. 9(C) illustrates R, X, and B from the first prefix 601(A) being used to extend the reg field 744 of the MOD R/M byte 702 and the index field 754 and base field 756 when the SIB byte 7 04 being used for memory addressing. FIG. 9(D) illustrates B from the first prefix 601(A) being used to extend the reg field 744 of the MOD R/M byte 702 when a register is encoded in the opcode 603.

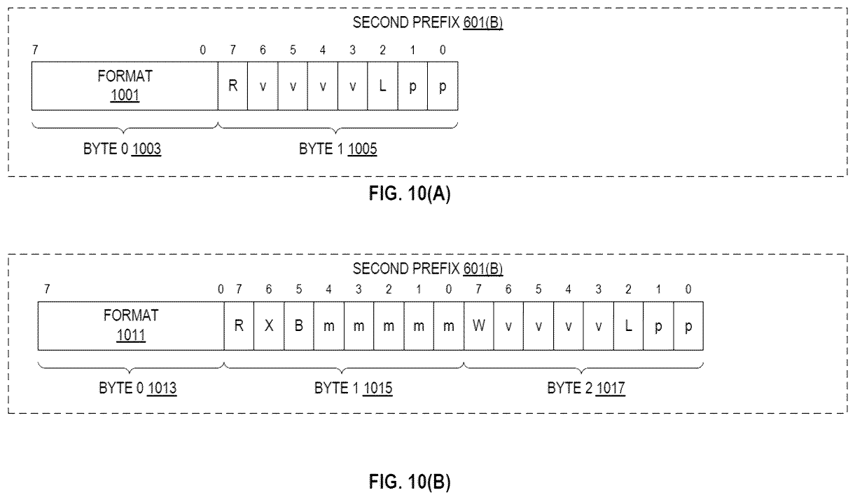

FIGS. 10(A)-(B) illustrate embodiments of a second prefix 601(B). In some embodiments, the second prefix 601(B) is an embodiment of a VEX prefix. The second prefix 601(B) encoding allows instructions to have more than two operands, and allows SIMD vector registers (e.g., vector/SIMD registers 510) to be longer than 64-bits (e.g., 128-bit and 256-bit). The use of the second prefix 601(B) provides for three-operand (or more) syntax. For example, previous two-operand instructions performed operations such as A=A+B, which overwrites a source operand. The use of the second prefix 601(B) enables operands to perform nondestructive operations such as A=B+C.

In some embodiments, the second prefix 601(B) comes in two forms—a two-byte form and a three-byte form. The two-byte second prefix 601(B) is used mainly for 128-bit, scalar, and some 256-bit instructions; while the three-byte second prefix 601(B) provides a compact replacement of the first prefix 601(A) and 3-byte opcode instructions.

FIG. 10(A) illustrates embodiments of a two-byte form of the second prefix 601(B). In one example, a format field 1001 (byte 0 1003) contains the value C5H. In one example, byte 1 1005 includes a “R” value in bit[7]. This value is the complement of the same value of the first prefix 601(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 746 to encode the instruction operand that references a memory address or encode either the destination register operand or a source register operand.

Instructions that use this prefix may use the Mod R/M reg field 744 to encode either the destination register operand or a source register operand, be treated as an opcode extension and not used to encode any instruction operand.

For instruction syntax that support four operands, vvvv, the Mod R/M R/M field 746 and the Mod R/M reg field 744 encode three of the four operands. Bits[7:4] of the immediate 609 are then used to encode the third source register operand.

FIG. 10(B) illustrates embodiments of a three-byte form of the second prefix 601(B). in one example, a format field 1011 (byte 0 1013) contains the value C4H. Byte 1 1015 includes in bits[7:5] “R,” “X,” and “B” which are the complements of the same values of the first prefix 601(A). Bits[4:0] of byte 1 1015 (shown as mmmmm) include content to encode, as need, one or more implied leading opcode bytes. For example, 00001 implies a OFH leading opcode, 00010 implies a OF38H leading opcode, 00011 implies a leading OF3AH opcode, etc.

Bit[7] of byte 2 1017 is used similar to W of the first prefix 601(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 746 to encode the instruction operand that references a memory address or encode either the destination register operand or a source register operand.

Instructions that use this prefix may use the Mod R/M reg field 744 to encode either the destination register operand or a source register operand, be treated as an opcode extension and not used to encode any instruction operand.

For instruction syntax that support four operands, vvvv, the Mod R/M R/M field 746, and the Mod R/M reg field 744 encode three of the four operands. Bits[7:4] of the immediate 609 are then used to encode the third source register operand.

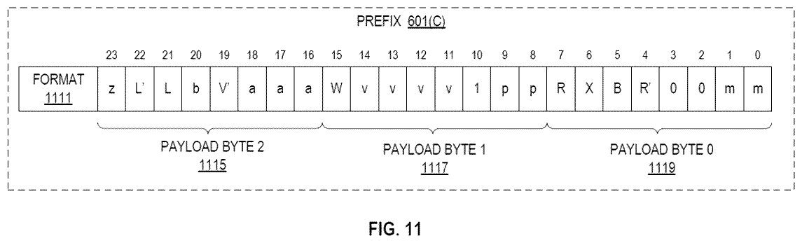

FIG. 11 illustrates embodiments of a third prefix 601(C). In some embodiments, the first prefix 601(A) is an embodiment of an EVEX prefix. The third prefix 601(C) is a four-byte prefix.

The third prefix 601(C) can encode 32 vector registers (e.g., 128-bit, 256-bit, and 512-bit registers) in 64-bit mode. In some embodiments, instructions that utilize a writemask/opmask (see discussion of registers in a previous figure, such as FIG. 5) or predication utilize this prefix. Opmask register allow for conditional processing or selection control. Opmask instructions, whose source/destination operands are opmask registers and treat the content of an opmask register as a single value, are encoded using the second prefix 601(B).

The third prefix 601(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 601(C) is a format field 1111 that has a value, in one example, of 62H. Subsequent bytes are referred to as payload bytes 1115-1119 and collectively form a 24-bit value of P[23:0] providing specific capability in the form of one or more fields (detailed herein).

In some embodiments, P[1:0] of payload byte 1119 are identical to the low two mmmmm bits. P[3:2] are reserved in some embodiments. Bit P[4] (R′) allows access to the high 16 vector register set when combined with P[7] and the ModR/M reg field 744. P[6] can also provide access to a high 16 vector register when SIB-type addressing is not needed. P[7:5] consist of an R, X, and B which are operand specifier modifier bits for vector register, general purpose register, memory addressing and allow access to the next set of 8 registers beyond the low 8 registers when combined with the ModR/M register field 744 and ModR/M R/M field 746. P[9:8] provide opcode extensionality equivalent to some legacy prefixes (e.g., 00=no prefix, 01=66H, 10=F3H, and 11=F2H). P[10] in some embodiments is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 601(A) and second prefix 611(B) and may serve as an opcode extension bit or operand size promotion.

P[18:16] specify the index of a register in the opmask (writemask) registers (e.g., writemask/predicate registers 515). In one embodiment of the invention, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While embodiments of the invention are described in which the opmask field's content selects one of a number of opmask registers that contains the opmask to be used (and thus the opmask field's content indirectly identifies that masking to be performed), alternative embodiments instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Exemplary embodiments of encoding of registers in instructions using the third prefix 601(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | ModR/M | GPR, Vector | Destination or Source |
| | | | reg | | |
| VVVV | V′ | vvvv | | GPR, Vector | 2nd Source or |
| | | | | | Destination |
| RM | X | B | ModR/M | GPR, Vector | 1st Source or |
| | | | R/M | | Destination |
| BASE | 0 | B | ModR/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | ModR/M reg | GPR, Vector | Destination or Source |
| VVVV | vvvv | GPR, Vector | 2^{nd} Source or Destination |
| RM | ModR/M R/M | GPR, Vector | 1^{st} Source or Destination |
| BASE | ModR/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | ModR/M Reg | k0-k7 | Source |
| VVVV | vvvv | k0-k7 | 2^{nd} Source |
| RM | ModR/M R/M | k0-7 | 1^{st} Source |
| {k1] | aaa | k0¹-k7 | Opmask |

Program code may be applied to input instructions to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

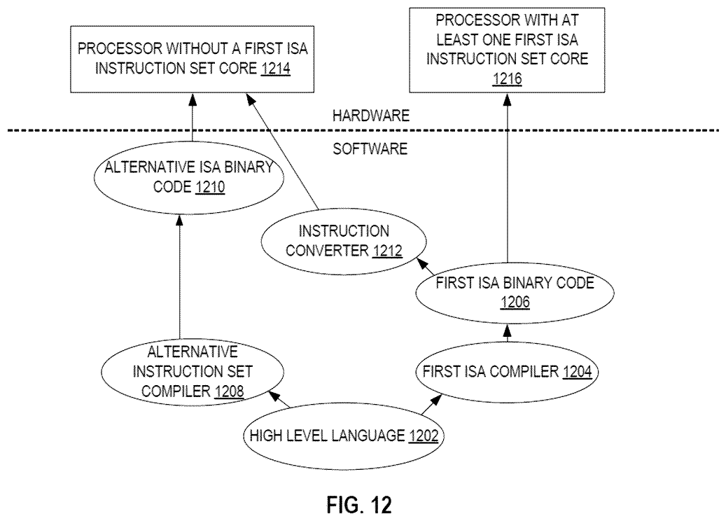

FIG. 12 illustrates a block diagram contrasting the use of a software instruction converter to convert binary instructions in a source instruction set to binary instructions in a target instruction set according to certain implementations. In the illustrated embodiment, the instruction converter is a software instruction converter, although alternatively the instruction converter may be implemented in software, firmware, hardware, or various combinations thereof. FIG. 12 shows a program in a high level language 1202 may be compiled using a first ISA compiler 1204 to generate first ISA binary code 1206 that may be natively executed by a processor with at least one first instruction set core 1216. The processor with at least one first ISA instruction set core 1216 represents any processor that can perform substantially the same functions as an Intel® processor with at least one first ISA instruction set core by compatibly executing or otherwise processing (1) a substantial portion of the instruction set of the first ISA instruction set core or (2) object code versions of applications or other software targeted to run on an Intel processor with at least one first ISA instruction set core, in order to achieve substantially the same result as a processor with at least one first ISA instruction set core. The first ISA compiler 1204 represents a compiler that is operable to generate first ISA binary code 1206 (e.g., object code) that can, with or without additional linkage processing, be executed on the processor with at least one first ISA instruction set core 1216.

Similarly, FIG. 12 shows the program in the high level language 1202 may be compiled using an alternative instruction set compiler 1208 to generate alternative instruction set binary code 1210 that may be natively executed by a processor without a first ISA instruction set core 1214. The instruction converter 1212 is used to convert the first ISA binary code 1206 into code that may be natively executed by the processor without a first ISA instruction set core 1214. This converted code is not likely to be the same as the alternative instruction set binary code 1210 because an instruction converter capable of this is difficult to make; however, the converted code will accomplish the general operation and be made up of instructions from the alternative instruction set. Thus, the instruction converter 1212 represents software, firmware, hardware, or a combination thereof that, through emulation, simulation or any other process, allows a processor or other electronic device that does not have a first ISA instruction set processor or core to execute the first ISA binary code 1206.

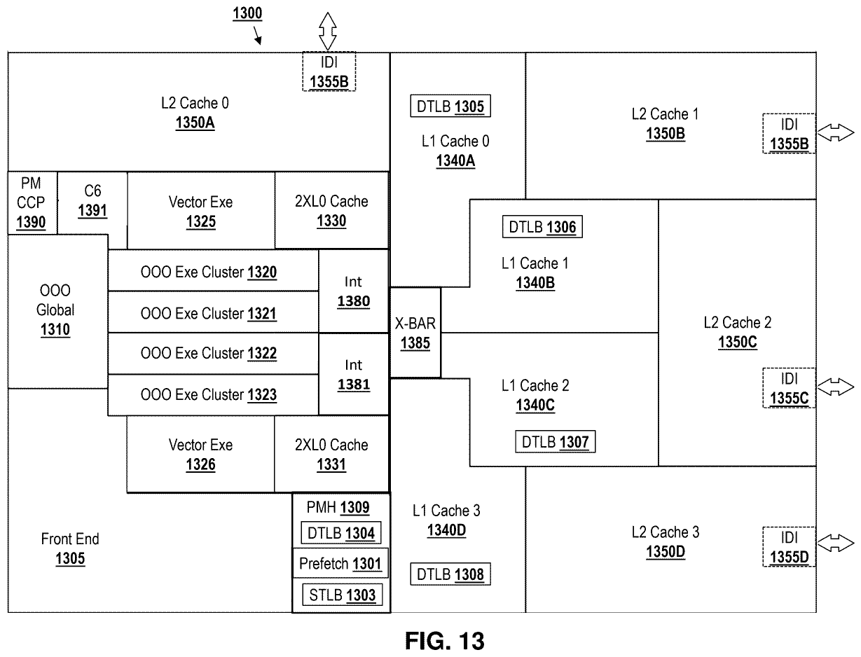

FIG. 13 illustrates an example processor 1300 (or processor tile integrated on the processor package with other processor tiles) on which the embodiments described herein may be implemented. Four out-of-order (OOO) processing clusters 1320-1323 with out-of-order instruction processing and execution circuitry are coupled to a corresponding plurality of L1 cache slices 1340A-D via a crossbar fabric 1385 via one or more respective interfaces 1380-1381. Front end circuitry 1305 performs instruction fetching and scheduling operations to dispatch the instructions to the 000 clusters 1320-1323 and/or global OOO circuitry 1310 which maintains global ordering in operations performed by the OOO clusters 1320-1323 while executing instructions. In certain examples, the OOO clusters 1320-1323 or the front end circuitry 1305 divide an instruction stream into groups of contiguous instructions or “strands,” several of which may be executed simultaneously on separate OOO clusters 1320-1323.

In the illustrated example, the processor includes a memory and cache subsystem comprising the L1 cache slices 1340A-D, as well as a set of L2 cache slices 1350A-D, which include respective in-die interconnects (IDIs) 1355A-D to couple to a next level cache (e.g., an L3 cache or LLC) and/or to a memory controller coupled to a system memory, such as a DDR DRAM memory (not shown). In some implementation, each OOO execution cluster 1323 and vector execution circuit 1325-1326 includes a set of interconnects to couple the 000 execution cluster 1320-1323 to each L1 cache slice 1340A-D (e.g., via the crossbar 1385).

Some processor components use virtual memory addresses which are translated to physical memory addresses via data-side translation lookaside buffers (DTLBs) 1304-1308 and one or more second level TLBs (STLB) 1303. A page miss handler (PMH) 1309 performs page walk operations in response to TLB misses (i.e., when a required virtual-to-physical address translation is not present in one of the TLBs). In some implementations, a primary DTLB 1304 is one of five DTLBs 1304-1308 distributed throughout the processor. In particular, each L1 data cache (D$) slice 1340A-D includes a respective DTLB 1305-1308, which are synchronized with the primary DTLB 1304. For example, the PMH 1309 or other logic may perform synchronization operations in response to TLB updates and invalidations to ensure that all five DTLB 1304-1308 are coherent with each other (i.e., continually updated to store the same set of entries).

Prefetch circuitry 1301 may observe patterns in STLB 1303 hits, learn whether the pattern is sequential or irregular, and manage a pattern table to identify the irregular patterns. When the prefetch circuitry 1301 decides to prefetch a TLB entry from the STLB 1303 to the DTLB 1304, it attempts to read the entry out of the STLB, but if it is not found in the STLB 1303, then the prefetch is dropped (i.e., the prefetch circuitry 1301 does not cause additional page walk operations).

Certain types of instructions may be executed by vector execution circuits 1325-1326, which include parallel execution circuitry for performing vector or tensor operations on vectors and matrices. Vector operations may be performed, for example, to process sets of data elements packed into SIMD/vector registers (e.g., fused multiply-accumulate operations, dot-product operations, etc). Tensor operations may be performed on multi-dimensional data elements (e.g., 2D matrices) packed into tile registers (e.g., groups of vector registers) to perform matrix operations (e.g., such as matrix multiplications described herein).

The other illustrated processor blocks include a power management circuit 1390 for performing power control operations such as voltage and PLL (i.e., frequency) regulation. A C6 circuit 1391 retains the execution state associated with one or more threads, strands, or instructions when one or more of the vector execution circuits 1325-1326 or OOO clusters 1320-1323 enter into a C6 low power state.

### Apparatus and Method for Memory Alias Disambiguation Training

As mentioned, in modern processors with wide memory pipelines, it is crucial that loads are able to make forward progress accurately to avoid bottlenecks in other parts of the pipeline. Prefetching with speculative load execution can be performed in an attempt to reduce load latency. However, one of the primary limitations with executing a speculative load is the inability to discern and skip past unresolved store addresses that are older than the speculative load.

Embodiments of the invention overcome this limitation using a combination of predictors which are trained to provide greater accuracy for identifying load uops which can be executed ahead of pending store uops. In particular, some embodiments include a store set predictor and a memory disambiguation (MD) predictor which are independently trained via training packets generated in response to the load uops. Each training packet may include a first set of training data usable to train the store set predictor and a second set of training data usable to train the MD predictor. In one implementation, the second set of training data comprises a subset of the first set of training data.

The training implementation may prioritize training of either the store set predictor or the MD predictor, depending on which was used by the load uop generating the training packet. For example, a load which uses the MD predictor circuitry may trigger training of the MD prediction circuitry while a load that uses the store set predictor circuitry may result in training of the store set predictor circuitry. The training of the store set predictor circuitry may include updating a confidence counter, updating the store set, or both. In these embodiments, detected memory order violations, invalidate, and clear operations train both predictors. Thus, the described embodiments unify two distinct memory disambiguation predictors, which operate in unison to achieve greater performance.

Some embodiments described herein provide out-of-order execution functionality which is to determine whether an order in which a load instruction and a store instruction are to be executed is to be different than some predefined execution order. Such embodiments identify a given one of the instructions based on a particular value of an instruction pointer (IP) (“instruction pointer value”) or a value derived from the IP value (e.g., a hash of the IP value, referred to as the CEIP). For example, a predefined execution order is indicated by a sequence of values of a corresponding instruction pointer, where a given instruction corresponds to a particular instruction pointer value in the sequence. Instructions of the given instruction type are subject to having different respective values of a given operand (e.g., including a memory address operand).

Embodiments of the invention efficiently process load instructions which include operands to identify memory addresses of data to be loaded from memory and store instructions which include operands to identify memory addresses to which data is to be stored to the memory. The “memory” in this example may comprise one or more physical memory devices across which a physical address space is mapped, and can include system memory devices (e.g., DDR DRAM devices) and on-processor cache memories. These embodiments may also utilize a virtual memory subsystem which maps virtual addresses used by certain IP blocks of the processor to physical addresses within the physical address space.

The term “address collision” refers herein to a type of event wherein two instructions—e.g., such as a load instruction and a store instruction—each target the same memory address. For example, an address collision is indicated by a data forwarding event wherein, before a load instruction has been executed, a store instruction is identified an execution unit of a processor as targeting the same memory address.

As used herein, “aliasing” refers to the characteristic of different types of instructions which are both involved in address collisions. For example, in some embodiments, two instruction types (e.g., a load instruction and a store instruction) are determined to be aliasing with respect to each other, where it is determined that the two instruction types target the same memory address. By contrast, an instruction type pair is determined to be non-aliasing, with respect to each other, where it is indicated, that respective instructions of the two instruction types tend to target different memory addresses.

As used herein, “aliasing load-store pair” refers to a combination of a load instruction and a store instruction which are each of a different respective instruction type of the same aliasing load-store type pair. It is to be noted that the instructions of a given aliasing load-store pair do not necessarily target the same memory address, but are expected—by virtue of their respective instruction types—to have an increased likelihood of targeting the same address.

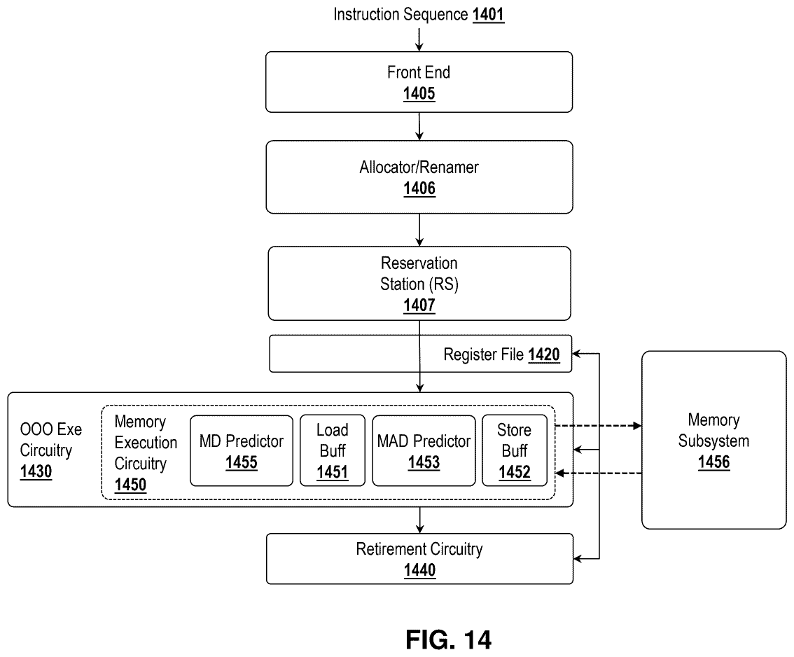

FIG. 14 illustrates an example core architecture on which embodiments of the invention may be implemented. Instructions of a particular instruction sequence 1401 (or multiple different instruction sequences) are fetched and decoded into microoperations (uops) by the front end 1405. The front end 1405 may include various additional circuitry not shown in FIG. 14, such as a level 1 (L1) instruction cache, a corresponding L1 data cache slice (e.g., one of slices 1340A-D), a branch predictor, a branch target buffer, a uop cache, and predication circuitry.

An allocator/renamer circuit 1406 allocates execution resources within the instruction pipeline and performs register renaming operations using registers from a physical register file 1420 (e.g., mapping logical registers to the physical registers) in accordance with source operand values and destination operand values of instructions of the instruction sequence 1401.

A reservation station (RS) 1405 selects uops to be dispatched for execution by 000 execution circuitry 1430 in accordance with one or more tracking data structures which track dependencies between the uops. In the embodiments described herein, the register file 1420 may include control and status registers, scalar registers, packed/SIMD data registers, and/or matrix registers (sometimes referred to as “tile” registers). Retirement circuitry 1440 may include a reorder buffer for retiring operations in the correct order and writing back/committing the results to the register file 1420 and/or the memory subsystem 1456 (assuming no exceptions occurred during execution).

The OOO execution circuitry 1430 executes the uops and includes memory execution circuitry 1450 for tracking and coordinating the execution of load uops and store uops based on dependencies between the load and store uops as described herein. A store buffer 1452 includes a store tracking data structure for tracking pending store uops and a load buffer 1451 includes a load tracking data structure for tracking pending load uops.

A memory disambiguation (MD) predictor 1455 predicts whether pending load uops can proceed speculatively, prior to older pending store uops. In some embodiments, the MD predictor 1455 includes a hash predictor array with entries associated with load uops, where each entry indicates a prediction of whether a corresponding load uop is to be allowed to access memory ahead of pending older store operations. The load buffer 1451 may also include a tracking table with entries corresponding to load uops, where each entry corresponds to a particular hash predictor array entry of the MD predictor 1455. In one embodiment, each entry indicates a prediction or confidence as to whether a pending load operation can access memory ahead of a pending older store operation. The prediction or confidence level depends upon the success of prior pending load operations corresponding to a particular predictor table entry. Confidence counters (e.g., saturation counters) may be updated to maintain predictions based on prior executions of the load uops (e.g., where larger counter values correspond to prior successful speculative executions of the corresponding load uops). A confidence counter may be reset (e.g., to 0) when the corresponding load uop has been determined to conflict with an older store uop. Performance is improved by the MD predictor 1455 due to the fact that load uops can be issued without waiting for the target addresses of older stores to be determined, the data from which can be used by the execution unit to dispatch subsequent operations from the scheduler/reservation station sooner.

A memory alias disambiguation (MAD) predictor 1453 performs store set predictions as described herein including maintaining one or more store set data structures to track executions of the load uops and store uops from which dependency predictions can be made (e.g., to distinguish aliased load and store uops from non-aliased load and store uops). The load and store uops may be sent to the memory subsystem 1455 to load data from or store data to the memory subsystem, respectively. In one embodiment, each entry of the MAD predictor includes a confidence level indicating confidence that a corresponding pending load operation can access memory ahead of a pending older store operation without creating a conflict. The confidence level may be updated based on the successes and failures of the execution of prior instances of the load uop. In some embodiments, the confidence level is maintained in a counter register which is incremented in response to prior successful executions of the corresponding load uop and decremented or reset in response to prior failed executions (e.g., in response to detected conflicts).

In some embodiments of the invention, a load uop may trigger training of the MD predictor 1455 or the MAD predictor 1453, depending on which was previously used by the load uop that is attempting to generate a training packet. For example, a load uop which previously used the MD predictor 1455 may trigger training of the MD prediction logic while a load that uses the MAD predictor 1453 may result in training of the corresponding store set predictor logic. The training of the store set predictor logic may include updating a confidence counter, updating the store set, or both. In these embodiments, detected memory order violations, invalidate, and clear operations train both predictors. Thus, the described embodiments unify two distinct memory alias predictors, which operate in unison to achieve greater performance.

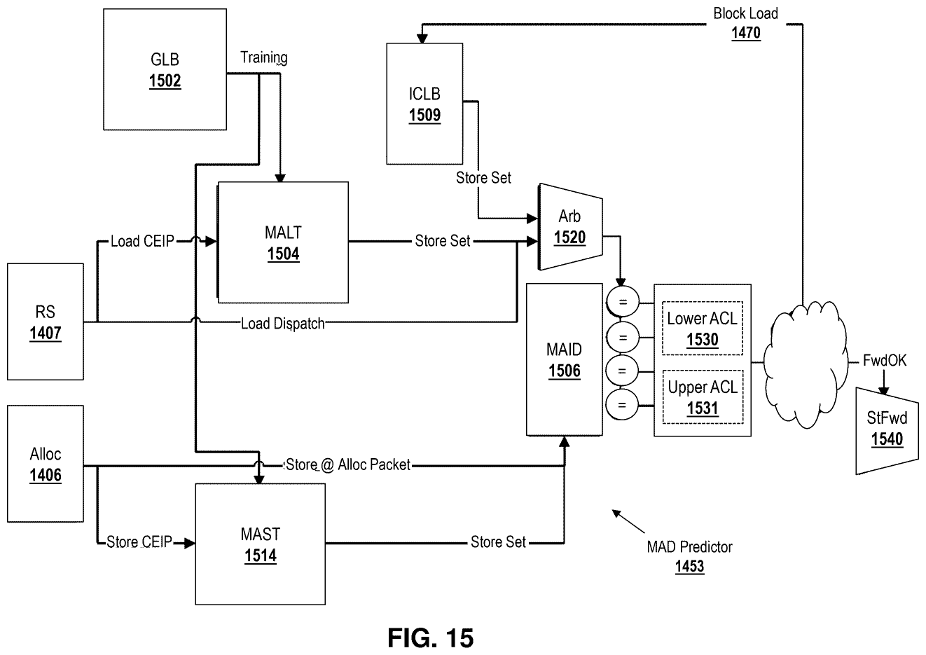

FIG. 15 illustrates an example embodiment of the memory alias disambiguation (MAD) predictor 1453 in accordance with embodiments of the invention including a memory disambiguation load table (MALT) 1524 and a memory disambiguation store table 1520 (MAST), each of which include a plurality of entries which store information to improve prediction accuracy for corresponding uops. For example, the MALT 1504 may include a plurality of entries related to load uops, including a store set ID (SSID) and a corresponding confidence counter value (both described further below). In some embodiments, the MALT 1524 is indexed based on the instruction pointer (IP) of each load instruction or a hash generated from the IP (referred to as the CEIP). Each entry associated with a load uop may include one or more store set IDs (SSIDs) corresponding to overlapping store uops (and potentially the CEIPs of the store uops) and a confidence counter value to indicate a confidence that the load uop should not pass the overlapping store uops (i.e., based on the corresponding SSIDs). The confidence counter may be set to a specified value (e.g., 4) when a load stalls on an overlapping STA of a store uop or encounters a memory order violation. A load uop no longer relies on the MAD predictor 1453 when its confidence counter is 0, at which point it may instead utilize the memory disambiguation (MD) predictor 1455 for predictions.

The MAST 1520 is indexed based on the IP of each store instruction or a hash generated from the IP (e.g., the CEIP). In one embodiment, each entry in the MAST 1520 corresponds to a different store uop and includes an assigned store set ID (SSID) (which may also be stored in MALT entries of overlapping load uops) and the store instruction's CEIP.

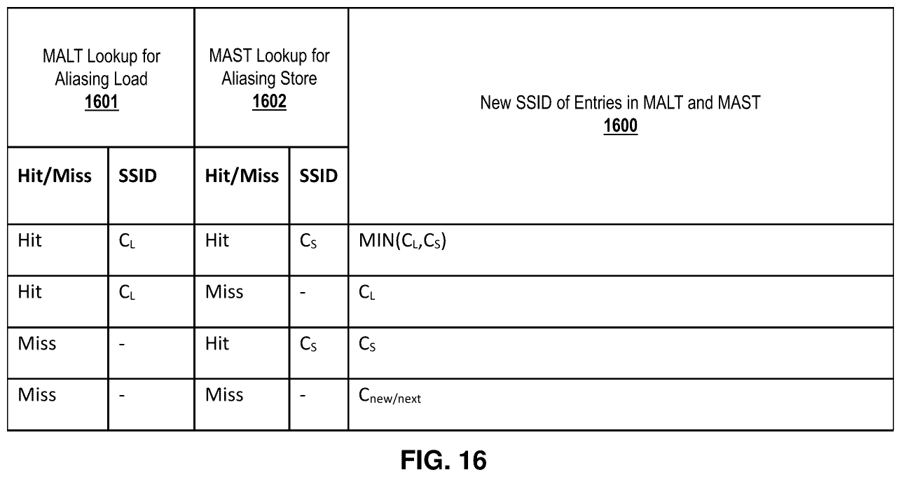

In accordance with these embodiments, upon discovering an aliasing load/store tuple, the aliasing load uop and the aliasing store uop are assigned the same Store Set ID (SSID). FIG. 16 illustrates a table indicating SSID assignments to be used for MALT lookups for load uops and MAST lookups for store uops in accordance with some implementations. When an overlapping relationship is detected between multiple store uops and a load uop, the CEIP of the latest store uop may be used to train the load. In the first row, for example, in response to a detected hit on a lookup to the MAD load table (MALT) 1504, indicated in the first column 1601, and the MAD store table (MAST) 1514, indicated in the second column 1602, the minimum of the two SSID values are selected for the entries in the MAD load table and MAD store table, respectively, as indicated in column 1600. In response to a hit in one of the MALT 1504 and the MAST 1514 and a miss in the other, the SSID corresponding to the hit is selected and is used for the corresponding entries in both the MALT 1504 and the MAST 1514. In response to misses in both the MALT 1501 and the MAST 1502, new SSID values are assigned (i.e., C_{new/next} as indicated in the rightmost column 1600).

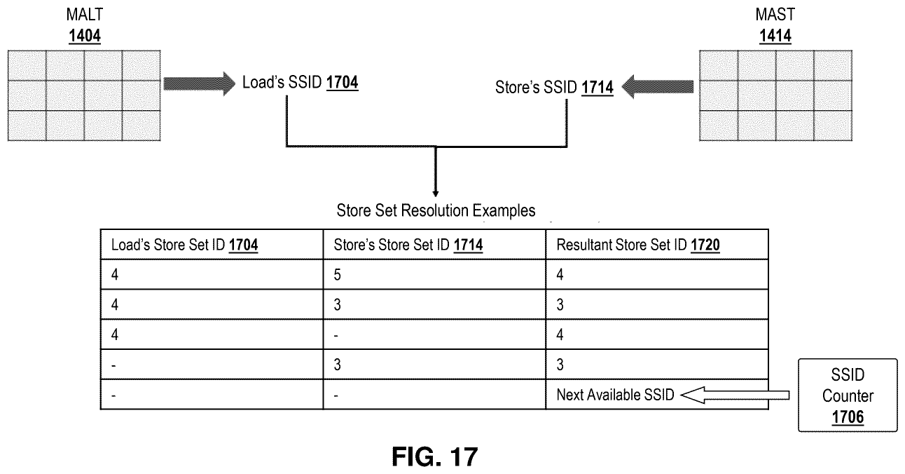

FIG. 17 illustrates another example for resolving SSID values 1704 in the MALT 1504 with corresponding store SSID values 1714 in the MAST 1404 to determine a resultant SSID 1720. In the first two columns, in response to SSID values 1704 from the MALT 1404 and SSID values 1714 from the MAST 1414, the smaller SSID value is selected as the resultant SSID 1720 (shown in the final column). In response to an SSID hit in only one of the MALT 1404 and the MAST 1414, the SSID corresponding to the hit is selected as the resultant SSID 1720.

As indicated in the final row, for misses in both the MALT 1404 and the MAST 1414, the next available SSID is generated for the resultant SSID 1720. In some embodiments, the MALT 1404 and/or the MAST 1414 include a store set ID generation counter 1706 to generate the next available SSID. By way of example, and not limitation, the SSID counter 1606 may be an 8-bit incrementing counter which generates the new SSID by incrementing the last generated SSID by one. In some implementations, the SSID counter 1706 wraps upon reaching a reserved invalid store set ID value (e.g., all 1s).

In some embodiments, only the oldest three loads across all L1 slices 1340A-D are eligible to send training packets to train the MAD predictor 1453. A load which forwards from a store with a different SSID may write the CEIP of the store in a Global Load Buffer (GLB) 1502 when operations in the corresponding L1 slice are complete (including loads that have invalid SSIDs). Additionally, if a store uop discovers a load overlap with respect to the store address (STA) in the GLB 1502, it stores its CEIP in the GLB 1502, overwriting any previously written store CEIP. When entries are deallocated at the GLB 1502, the L1 cache slices 1340A-D poll the oldest three loads, deallocating this cycle and allowing them to send MAD training packets. Failed loads and others in their shadow do not retire. Therefore, when a failure signal is received from the OOO execution circuitry 1430 for a failed load, this triggers transmission of the MAD training packet. No other younger load is allowed to send its training packet.

Because lookups to the MALT 1504 involve looking up the SSID and the corresponding confidence counter value, MAD training can be triggered with the intent of either adding a new store CEIP or updating the confidence counter value, meaning that a load can decide to send a MAD training packet if it has a valid confidence counter without having a new store CEIP to add. A load that received a confidence of 0 at the lookup to the MALT 1504 does not train the MAD predictor 1453. A MAD training packet may train the confidence counter in the MALT 1504 and also update the MALT 1504 and the MAST 1514 to specify a new load-store CEIP relationship. These two are distinct trainings and can happen in isolation of the other.

### Confidence Mechanisms

In-order to avoid unnecessary stalls, the MAD predictor 1453 include a confidence counter to monitor the utility of stalls introduced by it. The confidence counter may be decremented when a load stalls on a non-overlapping STA and may be set to a specified value (e.g., 4) when a load stalls on an overlapping STA or encounters a memory order violation. A load uop may rely on MAD prediction (e.g., overlap prediction based on the corresponding SSID) only when its confidence counter is not 0. When the confidence counter is 0, it may use the memory disambiguation (MD) predictor 1455 or no prediction (depending on whether the MD predictor 1455 is used). On a lookup to MALT 1404, a load uop is assigned the stored SSID if its confidence counter is not 0 and is assigned an invalid SSID if its confidence counter is 0 (e.g., an SSID value designated as invalid, such as eight 1s for an 8-bit counter).

In some embodiments, memory alias ID (MAID) comparison logic 1506 compares one or more store set ID values provided by MALT 1504 or the incomplete load buffer (ICLB) 1509 (selected by an arbitrator 1520, such as a multiplexer) with one or more SSID values from MAST 1514 to determine whether overlap exists. Alternatively, or additionally, lower address comparison logic 1530 and upper address comparison logic 1531 (sometimes referred to as “loosenet” and “finenet” logic, respectively) may compare the lower and upper address bits, respectively, of load and store uops. For example, lower address comparison logic 1530 may compare a lower portion (e.g., one or more of the least significant bits) of an address of a load uop with a corresponding lower portion of an address of one or more prior pending store operations. Similarly, upper address comparison logic 1531 may compare an upper portion of the address (e.g., one or more of the most significant bits) of the load uop with a corresponding upper portion of the address of the prior pending store operations. In some embodiments, the addresses used for comparisons are virtual addresses.

Regardless of the specific set of comparisons performed to determine address overlap, the results of the comparison may be used to determine whether to allow a store uop to forward its data directly to the corresponding load uop (e.g., represented by the Forward OK signal sent to store forward logic 1540 on a match).

In these embodiments, the Incomplete Load Buffer (ICLB) 1509 holds loads that have been executed (e.g., by a corresponding address generation unit (AGU)) in the memory execution circuitry 1450 and are logically part of the corresponding L1 cache slice 1340A-D, but have not yet completed (e.g., have not retired). In some embodiments, within the lower address comparison logic 1530 (loosenet), if a load carries a confident MAD prediction (i.e., with a confidence counter greater than a threshold, such as 0, 1, 2, etc) and blocks on an unresolved STA, a “block load” indication 1470 (e.g., in a packet) is written to the ICLB 1509 (e.g., in an entry corresponding to the load uop). When the load uop wakes up from the incomplete load buffer (ICLB) 1509 and redispatches, it checks whether it has an overlap with the STA it was previously blocked on. If a load uop does not hit a store uop it was previously blocked on in the lower address comparison logic 1530, then the confidence counter associated with the load uop (e.g., in the MALT 1504) is decremented, to indicate a MAD confidence decrease.

Similarly, within the upper address comparison logic 1531, if a load does not match a store it was previously blocked on, then the confidence counter associated with the load uop (e.g., in the MALT 1504) is decremented, to indicate a MAD confidence decrease. If the load uop matches the store uop it was previously blocked on, the confidence counter associated with the load uop (e.g., in the MALT 1504) is incremented, to indicate a MAD confidence increase.

In some embodiments, on a lookup to the MALT 1504, if the confidence counter is de-saturated to 0, it indicates that the MAD predictor 1453 is being too conservative. Thus, the MAD predictor 1453 may assign such loads a special invalid SSID. Such loads are not used for training and may continue to use predictions from the MD predictor 1455. The de-saturated confidence counter may still be updated in response to load failures. For example, the confidence counter may be fully saturated (e.g., to a maximum value, such as 4) when a load with 0 confidence fails.

A load uop can take multiple trips down the load pipeline in different confidence training situations. After every trip the load uop attempts to store its confidence training direction into the GLB 1502. If the GLB 1502 already has a confidence training from a previous trip, then the result is determined based on the following:
1. A confidence training direction of “increase confidence” is sticky and is given highest priority, meaning a load uop will always succeed in writing increase-confidence in the corresponding entry in the GLB 1502, and an entry in the GLB with increase-confidence training will never be overwritten.
2. If neither the GLB 1502 nor the load uop has a increase-confidence training, then decrease-confidence may be given priority over no-change-confidence. The priority is therefore: Increase-Confidence>Decrease-Confidence>No-Change-Confidence. A load uop entry in the GLB 1502 with confidence training of “increase” or “decrease” is a candidate for MAD training, notwithstanding any store CEIPs it might also hold. A load uop that receives a confidence of 0 in a lookup to the MALT 1504 does not train the MAD predictor 1453.

In some embodiments, memory disambiguation (MD) tables of the MD predictor 1455 are trained only if MAD for the load uop is not confident (e.g., a confidence value of 0). Depending on the interactions of the load uop with the rest of the memory subsystem 1455, three corresponding bits may be set or unset in the MD tables: (i) MD_UPDATE, indicating that the load uop came across an unresolved STA in the lower address comparison logic 1530; (ii) MD_DONE, indicating that the load uop skipped over an unresolved STA in the lower address comparison logic 1530; and/or MD_RESET, indicating that the load uop with MD_UPDATE=1 or MD_DONE=1 register a hit on the STA in the GLB 1502.

Load uops retired by retirement circuitry 1440 with the MD_UPDATE bit set to 1 are eligible to send MD training packets to train the MD predictor 1455. In some embodiments, training is performed based on the MD_RESET bit. For example, if the MD_RESET bit is 1, then the memory disambiguation (MD) saturation counter may be reset to 0. If the MD_RESET bit is 0, then the MD saturation counter is incremented. On a miss to the MD table, if the MD_RESET bit is 0, no new entry is installed.

### Training Bandwidth

In some embodiments, training packets are generated when a load is retired/deallocated from GLB 1502, or when the load uop generates a failure/clear signal to OOO execution circuitry 1430. The number of training packets that can be sent to the MD predictor in a cycle may be limited based on bandwidth constraints. For example, in one embodiment, the number is constrained to the three oldest loads per cycle. Each L1 slice 1340A-D sends up to three training candidates (e.g., the oldest three that need to train, resulting in 12 training candidates with four L1 slices 1340A-D). An aggregator may select the oldest three from these and send them to MD and MAD.

In some embodiments, a separate instance of the MALT 1504 and the MAST 1514 is configured for each L1 cache slice 1340A-B (e.g., four of each in accordance with these embodiments).

### MAD Training Generation Buffer

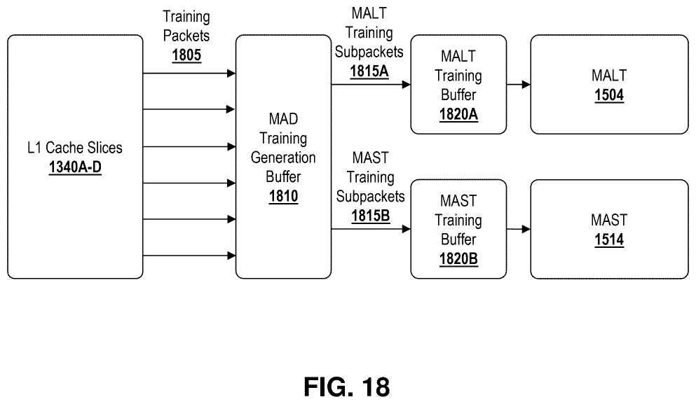

Referring to FIG. 18, due to the restriction that each L1 cache slice 1340A-D may only broadcast a single packet per cycle, a MAD training generation buffer 1810 is configured to collect training packets 1805 as they are generated. In one implementation, the MAD training generation buffer 1810 can hold up to 16 packets; once the buffer is full, new packets are dropped.

Since the MALT 1504 and the MAST 1514 need different subsets of the training data in order to update their respective tables, the training packets 1805 are split into two sub-packets, with one sub-packet 1815A sent to a MALT training buffer 1820A and the other sub-packet 1815B sent to a MAST training buffer 1820B. In one embodiment, each MALT training subpacket 1815B contains the load uop's CEIP, the load uop's Store Set ID (SSID), and the confidence training Indicator. Each MAST uop's training sub-packet 1815B contains the store uop's CEIP, and the store uop's SSID. The MALT training buffer 1820A and the MAST training buffer 1820B may be implemented as first-in-first-out (FIFO) buffers with read pointers pointing to the head of each respective buffer.

### MALT Training Buffer

As mentioned, there may be four instances of the MALT 1504 (i.e., one for each of the L1 cache slices 1340A-D). Each instance of the MALT training buffer 1820A is co-located with a corresponding instance of the MALT 1504. As packets arrive at the MALT training buffer 1820A, up to four per cycle (one per slice), they may be written into per-MALT-bank buffers, each with four entries. In some implementations, once a bank buffer becomes full, new packets are dropped.

Each cycle, the head of each FIFO will override the read port with the highest index (training packets have highest priority) and perform a tag comparison to find the way it needs to update. Due to the latency between when the CEIPs are used read the MALT 1504 and when the training packet arrives, it is possible that the CEIP no longer exists in the set-associative structure. In the case of a training packet read miss, the training makes one of two decisions: (1) if the training packet was attempting to modify the confidence counter, the packet is dropped (i.e., the write does not happen); (2) if the training packet was attempting to update the Store Set ID, a victim will be selected and the new information will be written into the table.

In some embodiments, due to the clocked-read nature of the MALT 1504, confidence training is a multi-cycle operation. To avoid a confidence training update overwriting a Store Set ID update in the previous cycle, a bypass is used to detect this case. If a confidence training packet attempts to modify the same set/way that was just modified by a Store Set ID update packet, the confidence training packet is dropped.

In some implementations, PLRU (pseudo least recently used) array instance to select victim entries is co-located with each instance of the MALT 1504. Since the MALT instances are not co-located, and the reads on each MALT instance are distinct, utilizing the actual read hits is not possible; instead, the PLRU relies on training packets to create “hit” updates.

### MAST Training Buffer

In some embodiments, each instance of the MAST training buffer 1820B is co-located with each instance of the MAST 1514. As packets arrive at the MAST training buffer 1820B, up to four per cycle (one per slice), they are written into per-MAST-bank buffers; each of which has four entries. Once a buffer becomes full, new packets are dropped.

Each cycle, the head of each FIFO will override the read port with the highest index (training packets have highest priority) and perform a tag comparison to find the way it needs to update. Due to the latency between when the CEIPs read the MAST and when the training packet arrives, it is possible that the CEIP no longer exists in the set-associative structure. In the case of a training packet read miss, since the MAST training only updates the Store Set IDs, a victim will be selected and the new information will be written into the table.

As with the MALT, a MAST PLRU array instance may be co-located with each instance of the MAST 1514. In some embodiments, there is only a single instance of the MAST 1514 and read hits are used to update the PLRU trees managed in the PLRU instance. For example, The MAST may use the PLRU array to select victims.

### MAD Store Set ID Generation

As mentioned in the training buffer sections above, once the buffers become full, new packets are dropped. However, this can be problematic. For example, if the MAST training buffer 1820B is not full but the MALT training buffer 1820A is full, one table will be updated with its packet while the other table will not, which can lead to issues with generating new Store Set IDs, as the generation point cannot be at the time of MALT/MAST writes. Instead, any packet indicating a new Store Set ID will automatically cause a corresponding SSID counter 1706 to generate a new SSID as the packet enters the buffers 1820A-B, prior to being written into the buffers and prior to being dropped due to the buffers being full. In this way, even if half of a training packet is dropped, the Store Set ID generation counters 1706 remain in sync across all MALT and MAST instances.

### MD Training

Memory disambiguation (MD) training packets for providing updates to the MD predictor 1455 may be generated at the retirement circuitry 1440, in contrast to MAD training packets which are generated in the load pipeline of the memory execution circuitry 1450. In some embodiments, the MD predictor 1455 and MAD predictor 1453 share the MAD training generation buffers 1810 and the path from there to the consumers.

To determine whether the training packet should be used to train the MD predictor 1455 or the MAD predictor 1453, one embodiment of the GLB 1502 will check to see if the MAD predictor 1453 had a confidence at or below a threshold for a given load uop (i.e., the MAD confidence is 0). This results in loads that used a MAD prediction training the MAD predictor 1453, and loads that used the MD prediction training the MD predictor 1455.

In some implementations, each GLB 1502 on each cycle will select up to four loads attempting to train the MD predictor 1455 from the GLB 1502 (e.g., at retirement). To reduce wires over the crossbar, one packet per GLB 1502 per cycle may be sent to the MD predictor 1455 tables for training (sharing the same bus as MAD training).

In some embodiments, when the MAD predictor 1453 is not confident in the load (i.e., MAD is not allowed), then MD-specific training packets are generated when MD_UPDATE (MDU)==1, which indicates that the load uop saw an older unknown STA somewhere in the loosenet search range; MD_RESET (MDR)==1, indicating when a load with MD_UPDATE==1 is hit by any older STA in the GLB (the STA must be older but does not need to have been skipped); and/or MD_RESET (MDR)==0, indicating that the load with MD_UPDATE==1 is never hit by any older STA in GLB.

Any load which has MAD_ALLOWED==0 and MDU set to 1 may attempt to train the MD predictor 1455. If MDR is set, a “reset” packet is generated; otherwise an “increment” packet is generated. Clears and failure conditions due to STA hits will also trigger a training packet. These packets train both the MD predictor 1455 and the MAD predictor 1453. In the case of the MD predictor 1455, the confidence level is reset (equivalent to an MDU+MDR training packet).

If training of the MD predictor 1455 is required, a packet is generated with the following fields (which are a subset of the fields of MAD packets): Valid; Load CEIP; and MD Increment/Reset. Since the MD training packets share the MAD training generation buffer 1810, they also share the training pipelines. However, since the MD predictor 1455 does not use the MALT and MAST tables, the MD packets are forwarded from the corresponding instances of the MALT 1404 to the memory execution circuitry 1450, which consume the MD packets and updates the MD tables.

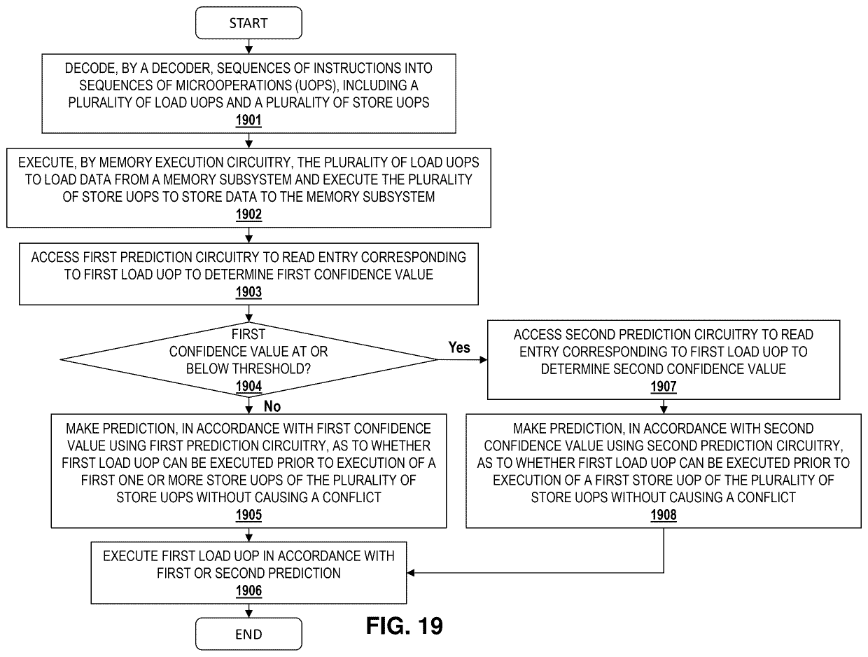

A method in accordance with some embodiments is illustrated in FIG. 19. The method may be implemented on the various architectures described herein, but is not limited to any particular processor or system architecture.

At 1901, sequences of instructions are decoded by a decoder into sequences of microoperations (uops), including a plurality of load uops and a plurality of store uops.

At 1902, the plurality of load uops are executed by memory execution circuitry to load data from a memory subsystem and the plurality of store uops are executed to store data to the memory subsystem

At 1903, first prediction circuitry (e.g., a store set predictor) is accessed to read an entry corresponding to the first load uop to determine a first confidence value associated with the first load uop. If the first confidence value is greater than a first threshold (e.g., 0), determined at 1904, then at 1905 a prediction is made, in accordance with the first confidence value using first prediction circuitry, as to whether the first load uop can be executed prior to execution of a first one or more store uops of the plurality of store uops without causing a conflict. At 1906, the first load uop is executed in accordance with the first prediction.

If the second confidence value is at or below the first threshold (e.g., 0) at 1904, then at 1907, second prediction circuitry (e.g., an MD predictor) is accessed to read an entry corresponding to the first load uop to determine a second confidence value. At 1908, a prediction is made, in accordance with a second confidence value (e.g., from the entry) using second prediction circuitry, as to whether the first load uop can be executed prior to execution of a first store uop without causing a conflict. At 1906, the first load uop is executed in accordance with the second prediction.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals-such as carrier waves, infrared signals, digital signals, etc.).

### EXAMPLES

The following are example implementations of different embodiments of the invention.

### Example 1

A processor, comprising: decode circuitry to decode sequences of instructions into sequences of microoperations (uops), including a plurality of load uops and a plurality of store uops; memory execution circuitry to execute the plurality of load uops to load data from a memory subsystem and to execute the plurality of store uops to store data to the memory subsystem; and memory alias disambiguation (MAD) prediction circuitry to make a prediction as to whether a first load uop of the plurality of load uops can be executed prior to execution of a first one or more store uops of the plurality of store uops without causing a conflict, the MAD circuitry to make the prediction based on first prediction circuitry when a first confidence value indicated by the first prediction circuitry is above a threshold and to make the prediction based on second prediction circuitry when the first confidence value is at or below the threshold.

### Example 2

The processor of example 1, further comprising: training circuitry to train at least one of the first prediction circuitry and the second prediction circuitry responsive to the first load uop completing execution or retiring, triggering a memory order violation, and/or generating a fault condition.

### Example 3

The processor of examples 1 or 2, wherein the training circuitry comprises training packet generation logic to generate a training packet responsive to the first load uop.

### Example 4

The processor of any of examples 1-3, wherein both the first prediction circuitry and second prediction circuitry are to be trained by the training packet if the first load uop triggered a memory order violation or generated a fault and wherein one of the first or second prediction circuitry used to make the prediction are to be trained by the training packet responsive to the first load uop completing execution or retiring.

### Example 5

The processor of any of examples 1-4, wherein the first prediction circuitry comprises a first tracking data structure, a first entry of the first tracking data structure to correspond to the first load uop, the first entry to indicate the first confidence value and a first store set identifier (SSID) associated with a first one or more store uops of the plurality of store uops determined to overlap with the first load uop, the first prediction circuitry to predict that the first load uop can be executed prior to execution of the first one or more store uops when the first confidence value is above the threshold.

### Example 6

The processor of any of examples 1-5, wherein the first prediction circuitry comprises a second tracking data structure, a first entry of the second tracking data structure to correspond to the one or more store uops associated with the first SSID.

### Example 7

The processor of any of examples 1-6, wherein the second prediction circuitry comprises a memory disambiguation (MD) predictor to be accessed by the MAD prediction circuitry to determine whether the first load uop can be executed speculatively prior to execution of a first store uop of the first one or more store uops.

### Example 8

The processor of any of examples 1-7, wherein the MD predictor comprising a hash predictor array with a first entry corresponding to the first load uop, the first entry to indicate a second confidence value associated with the first load uop, the MAD prediction circuitry to make the prediction based, at least in part, on the second confidence value.

### Example 9

The processor of any of examples 1-8, wherein the second confidence value is provided by a first saturation counter, the first saturation counter to be incremented when the first load uop, when executed, does not produce a memory order violation with respect to the first store uop.

### Example 10

A method, comprising: decoding, by a decoder, sequences of instructions into sequences of microoperations (uops), including a plurality of load uops and a plurality of store uops; executing, by memory execution circuitry, the plurality of load uops to load data from a memory subsystem and to execute the plurality of store uops to store data to the memory subsystem; and making a prediction, by memory alias disambiguation (MAD) prediction circuitry, as to whether a first load uop of the plurality of load uops can be executed prior to execution of a first one or more store uops of the plurality of store uops without causing a conflict, wherein the prediction is to be made based on first prediction circuitry when a first confidence value indicated by the first prediction circuitry is above a threshold and is to be made based on second prediction circuitry when the first confidence value is at or below the threshold.

### Example 11

The method of example 10, further comprising: training at least one of the first prediction circuitry and the second prediction circuitry responsive to the first load uop completing execution or retiring, triggering a memory order violation, and/or generating a fault condition.

### Example 12

The method of examples 10 or 11, wherein training further comprises generating a training packet responsive to the first load uop.

### Example 13

The method of any of examples 10-12, wherein both the first prediction circuitry and second prediction circuitry are to be trained by the training packet if the first load uop triggered a memory order violation or generated a fault and wherein one of the first or second prediction circuitry used to make the prediction are to be trained by the training packet responsive to the first load uop completing execution or retiring.

### Example 14

The method of any of examples 10-13, wherein the first prediction circuitry comprises a first tracking data structure, a first entry of the first tracking data structure to correspond to the first load uop, the first entry to indicate the first confidence value and a first store set identifier (SSID) associated with a first one or more store uops of the plurality of store uops determined to overlap with the first load uop, the first prediction circuitry to predict that the first load uop can be executed prior to execution of the first one or more store uops when the first confidence value is above the threshold.

### Example 15

The method of any of examples 10-14, wherein the first prediction circuitry comprises a second tracking data structure, a first entry of the second tracking data structure to correspond to the one or more store uops associated with the first SSID.

### Example 16

The method of any of examples 10-15, wherein the second prediction circuitry comprises a memory disambiguation (MD) predictor to be accessed by the MAD prediction circuitry to determine whether the first load uop can be executed speculatively prior to execution of a first store uop of the first one or more store uops.

### Example 17

The method of any of examples 10-16, wherein the MD predictor comprising a hash predictor array with a first entry corresponding to the first load uop, the first entry to indicate a second confidence value associated with the first load uop, the MAD prediction circuitry to make the prediction based, at least in part, on the second confidence value.

### Example 18

The method of any of examples 10-17, wherein the second confidence value is provided by a first saturation counter, the first saturation counter to be incremented when the first load uop, when executed, does not produce a memory order violation with respect to the first store uop.

### Example 19

A machine-readable medium having program code stored thereon which, when executed by a machine, causes the machine to perform operations, comprising: decoding, by a decoder, sequences of instructions into sequences of microoperations (uops), including a plurality of load uops and a plurality of store uops; executing, by memory execution circuitry, the plurality of load uops to load data from a memory subsystem and to execute the plurality of store uops to store data to the memory subsystem; and making a prediction, by memory alias disambiguation (MAD) prediction circuitry, as to whether a first load uop of the plurality of load uops can be executed prior to execution of a first one or more store uops of the plurality of store uops without causing a conflict, wherein the prediction is to be made based on first prediction circuitry when a first confidence value indicated by the first prediction circuitry is above a threshold and is to be made based on second prediction circuitry when the first confidence value is at or below the threshold.

### Example 20

The method of examples 19 or 20, further comprising program code to cause the machine to perform operations, comprising: training at least one of the first prediction circuitry and the second prediction circuitry responsive to the first load uop completing execution or retiring, triggering a memory order violation, and/or generating a fault condition.

In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. A processor, comprising:
decode circuitry to decode sequences of instructions into sequences of microoperations (uops), including a plurality of load uops and a plurality of store uops;
memory execution circuitry to execute the plurality of load uops to load data from a memory subsystem and to execute the plurality of store uops to store data to the memory subsystem; and
memory alias disambiguation (MAD) prediction circuitry to make a prediction as to whether a first load uop of the plurality of load uops can be executed prior to execution of a first one or more store uops of the plurality of store uops without causing a conflict, the MAD circuitry to make the prediction based on first prediction circuitry when a first confidence value indicated by the first prediction circuitry is above a threshold and to make the prediction based on second prediction circuitry when the first confidence value is at or below the threshold.

2. The processor of claim 1, further comprising:
training circuitry to train at least one of the first prediction circuitry and the second prediction circuitry responsive to the first load uop completing execution or retiring, triggering a memory order violation, and/or generating a fault condition.

3. The processor of claim 2, wherein the training circuitry comprises training packet generation logic to generate a training packet responsive to the first load uop.

4. The processor of claim 3, wherein both the first prediction circuitry and second prediction circuitry are to be trained by the training packet if the first load uop triggered a memory order violation or generated a fault and wherein one of the first or second prediction circuitry used to make the prediction are to be trained by the training packet responsive to the first load uop completing execution or retiring.

5. The processor of claim 1, wherein the first prediction circuitry comprises a first tracking data structure, a first entry of the first tracking data structure to correspond to the first load uop, the first entry to indicate the first confidence value and a first store set identifier (SSID) associated with a first one or more store uops of the plurality of store uops determined to overlap with the first load uop, the first prediction circuitry to predict that the first load uop can be executed prior to execution of the first one or more store uops when the first confidence value is above the threshold.

6. The processor of claim 5, wherein the first prediction circuitry comprises a second tracking data structure, a first entry of the second tracking data structure to correspond to the one or more store uops associated with the first SSID.

7. The processor of claim 1, wherein the second prediction circuitry comprises a memory disambiguation (MD) predictor to be accessed by the MAD prediction circuitry to determine whether the first load uop can be executed speculatively prior to execution of a first store uop of the first one or more store uops.

8. The processor of claim 7, wherein the MD predictor comprising a hash predictor array with a first entry corresponding to the first load uop, the first entry to indicate a second confidence value associated with the first load uop, the MAD prediction circuitry to make the prediction based, at least in part, on the second confidence value.

9. The processor of claim 1, wherein the second confidence value is provided by a first saturation counter, the first saturation counter to be incremented when the first load uop, when executed, does not produce a memory order violation with respect to the first store uop.

10. A method, comprising:
decoding, by a decoder, sequences of instructions into sequences of microoperations (uops), including a plurality of load uops and a plurality of store uops;
executing, by memory execution circuitry, the plurality of load uops to load data from a memory subsystem and to execute the plurality of store uops to store data to the memory subsystem; and
making a prediction, by memory alias disambiguation (MAD) prediction circuitry, as to whether a first load uop of the plurality of load uops can be executed prior to execution of a first one or more store uops of the plurality of store uops without causing a conflict, wherein the prediction is to be made based on first prediction circuitry when a first confidence value indicated by the first prediction circuitry is above a threshold and is to be made based on second prediction circuitry when the first confidence value is at or below the threshold.

11. The method of claim 10, further comprising:
training at least one of the first prediction circuitry and the second prediction circuitry responsive to the first load uop completing execution or retiring, triggering a memory order violation, and/or generating a fault condition.

12. The method of claim 11, wherein training further comprises generating a training packet responsive to the first load uop.

13. The method of claim 12, wherein both the first prediction circuitry and second prediction circuitry are to be trained by the training packet if the first load uop triggered a memory order violation or generated a fault and wherein one of the first or second prediction circuitry used to make the prediction are to be trained by the training packet responsive to the first load uop completing execution or retiring.

14. The method of claim 10, wherein the first prediction circuitry comprises a first tracking data structure, a first entry of the first tracking data structure to correspond to the first load uop, the first entry to indicate the first confidence value and a first store set identifier (SSID) associated with a first one or more store uops of the plurality of store uops determined to overlap with the first load uop, the first prediction circuitry to predict that the first load uop can be executed prior to execution of the first one or more store uops when the first confidence value is above the threshold.

15. The method of claim 14, wherein the first prediction circuitry comprises a second tracking data structure, a first entry of the second tracking data structure to correspond to the one or more store uops associated with the first SSID.

16. The method of claim 10, wherein the second prediction circuitry comprises a memory disambiguation (MD) predictor to be accessed by the MAD prediction circuitry to determine whether the first load uop can be executed speculatively prior to execution of a first store uop of the first one or more store uops.

17. The method of claim 16, wherein the MD predictor comprising a hash predictor array with a first entry corresponding to the first load uop, the first entry to indicate a second confidence value associated with the first load uop, the MAD prediction circuitry to make the prediction based, at least in part, on the second confidence value.

18. The method of claim 10, wherein the second confidence value is provided by a first saturation counter, the first saturation counter to be incremented when the first load uop, when executed, does not produce a memory order violation with respect to the first store uop.

19. A machine-readable medium having program code stored thereon which, when executed by a machine, causes the machine to perform operations, comprising:
decoding, by a decoder, sequences of instructions into sequences of microoperations (uops), including a plurality of load uops and a plurality of store uops;
executing, by memory execution circuitry, the plurality of load uops to load data from a memory subsystem and to execute the plurality of store uops to store data to the memory subsystem; and
making a prediction, by memory alias disambiguation (MAD) prediction circuitry, as to whether a first load uop of the plurality of load uops can be executed prior to execution of a first one or more store uops of the plurality of store uops without causing a conflict, wherein the prediction is to be made based on first prediction circuitry when a first confidence value indicated by the first prediction circuitry is above a threshold and is to be made based on second prediction circuitry when the first confidence value is at or below the threshold.

20. The method of claim 19, further comprising program code to cause the machine to perform operations, comprising:
training at least one of the first prediction circuitry and the second prediction circuitry responsive to the first load uop completing execution or retiring, triggering a memory order violation, and/or generating a fault condition.
